(19) United States
(12) Patent Application Publication
(10) Pub. No.: US 2025/0170971 A1
(43) Pub. Date: May 29, 2025

(54) VEHICLE WIRING FIXTURE FOR MOUNTING WIRING INSTALLED BETWEEN A PILLAR AND PILLAR TRIM

(71) Applicant: DAEHAN SOLUTION CO., LTD., Incheon (KR)

(72) Inventors: CHOONG HO KWON, SEOUL (KR); MIN-YONG RYU, Incheon (KR)

(21) Appl. No.: 18/932,733

(22) Filed: Oct. 31, 2024

(30) Foreign Application Priority Data
Nov. 23, 2023 (KR) 10-2023-0164040

(51) Int. Cl. B60R 16/02

(52) U.S. Cl. CPC B60R 16/0215

(57) ABSTRACT

The present invention relates to a vehicle wiring fixture used for mounting a wiring installed between a pillar A and a pillar trim, in which a holding part may be formed on a wiring fixture used for mounting the wiring, and the wiring inserted into the wiring fixture may be caught on the holding part, thereby preventing a mounting hole used for mounting the pillar trim on the pillar A from being covered by the wiring due to the wiring sagging downward and easily and conveniently assembling the pillar trim.

### CROSS-REFERENCE TO RELATED APPLICATION

This application claims priority to and the benefit of Korean Patent Application No. 10-2023-0164040, filed on Nov. 23, 2023, the disclosure of which is incorporated herein by reference in its entirety.

### BACKGROUND

### 1. Field of the Invention

The present invention relates to a vehicle wiring fixture for mounting a wiring installed between a pillar A and a pillar trim, and more specifically, to a vehicle wiring fixture, in which a holding part is additionally formed on a wiring fixture, which is used to fix a wire installed between a pillar A and a pillar trim, to support the fixed wire, thereby preventing a mounting hole of the pillar A used when mounting the pillar trim on the pillar A from being covered due to the wiring sagging to easily, conveniently, and accurately mount the pillar A on the pillar trim. In this case, as a guide is formed in the holding part and a guide hole is additionally formed above the mounting hole in the pillar A, the holding part may stably support the wiring and not sag downward, thereby assembling the pillar trim onto the pillar A even more easily and conveniently.

### 2. Discussion of Related Art

Generally, finishing of a pillar supporting a roof panel of a vehicle is performed along with a pillar trim in a vehicle indoors as provided in Patent Documents 1 to 3 below, and in this case, a configuration such as a wiring for distributing power to a headliner is mounted between a pillar A and a pillar trim.

(Patent Document 1) Korean Laid-Open Patent No. 10-2013-0068695)

Patent Document 1 relates to a clip structure of a vehicle front pillar trim, and the clip structure may be composed of an inner clip of which one end is fixedly mounted on the front pillar trim of the vehicle and an outer clip which is slidably provided on an outer circumferential surface of the inner clip in a front-rear direction and of which an outer end is fixedly mounted to a front pillar panel, thereby improving the mounting performance of the front pillar trim and the front pillar panel of the vehicle to increase marketability, and at the same time, easily separating the front pillar trim and the front pillar panel when deploying an airbag in order to improve stability.

(Patent Document 2) Korean Patent Registration No. 10-0402121

Patent Document 2 relates to a vehicle pillar trim fixing device, in which an elastic piece having a locking portion is installed at one side of a pillar, a coupling rod is automatically locked to the locking portion of the elastic piece when the coupling rod is formed on an inner surface of a pillar trim to push the pillar trim against the pillar, and conversely, when an end of the elastic piece is folded, the coupling rod may be easily detached from the locking portion of the elastic piece, and the vehicle pillar trim fixing device which fixes the pillar trim to an inner front surface of the pillar, includes a housing installed by being inserted into a front surface of the pillar and having a box shape with an insertion hole in the front surface thereof, an elastic piece having one end fixed to an inner bottom surface of the housing, the other end partially exposed to the outside under the pillar trim, and a middle having a locking portion, and a coupling rod fixed to an inner surface of the pillar trim and having a hook portion at an end thereof to be elastically coupled to the locking portion.

(Patent Document 3) Korean Patent Registration No. 10-0666785

Patent Document 3 relates to a method of manufacturing a vehicle pillar trim, and more specifically, to a method of manufacturing a vehicle pillar trim which, to solve the conventional problem in which a wrinkle phenomenon occurs when a skin member is attached to a base substrate using an adhesive in manufacturing a pillar trim having a deep drawing shape, by primarily vacuum-molding the skin member and secondarily injecting the base substrate into the vacuum-molded skin member at the same time, it is possible to provide a pillar trim having a clean surface without any wrinkle and improve workability by excluding the conventional process of applying an adhesive. That is, there is provided the method of manufacturing the vehicle pillar trim which, by providing the method of manufacturing the vehicle pillar trim which includes a process of vacuum-molding the skin member formed of an outer skin and a PP foam sheet as a primary process and a process of injecting the base substrate into the vacuum-molded skin member at the same time as a secondary process, it is possible to provide the pillar trim having a clean surface without any wrinkle and improve workability by excluding the conventional process of applying the adhesive.

### RELATED ART DOCUMENTS

### Patent Documents

(Patent Document 1) Korean Laid-Open Patent No. 10-2013-0068695 (published date: Jun. 26, 2013)

(Patent Document 2) Korean Patent Registration No. 10-0402121 (registered date: Oct. 2, 2003)

(Patent Document 3) Korean Patent Registration No. 10-0666785 (registered date: Jan. 3, 2007)

### SUMMARY OF THE INVENTION

However, when wires are mounted between the conventional A pillar and pillar trim, the following problems occur.

(1) As the number of electrical and electronic devices mounted in a vehicle indoors increases, power consumption increases as well. As described above, when the number of electrical and electronic devices increases, the power consumed in this case also increases, and thus wiring that is branched from a battery to a headliner needs to be thicker.

(2) In this case, the wiring for the electrical and electronic devices mounted on the headliner is mounted in a space formed between a pillar A and a pillar trim to supply required power. Therefore, as the wiring becomes thicker, a cross section becomes larger as the wiring becomes thicker, and thus a cross-sectional area between the pillar A and the pillar trim also becomes larger.

(3) As the cross-sectional area of the wiring becomes larger, it becomes more difficult to assemble the pillar trim installed in the vehicle indoors to face the pillar A. That is, as the thickness of the wiring becomes larger, a weight per unit length becomes heavier together with its cross section, and thus the phenomenon of covering a mounting hole formed in the pillar A when assembling the pillar trim on the pillar A occurs due to the wire sagging.

(4) This degrades productivity due to an increase in time required to assemble the pillar trim onto the pillar A and degrades quality due to poor assembly because the assembly is performed at a position distanced from a predetermined assembly position.

Considering such a point, the present invention is directed to providing a vehicle wiring fixture used for mounting a wiring installed between a pillar A and a pillar trim, in which a holding part may be formed on a wiring fixture used for mounting a wiring, and the wiring inserted into the wiring fixture may be held by the holding part, thereby preventing a mounting hole used for mounting the pillar trim on the pillar A from being covered by the wiring as the wiring sags downward and easily and conveniently assembling the pillar trim.

In particular, the present invention is directed to providing a vehicle wiring fixture used for mounting a wiring installed between a pillar A and a pillar trim, in which a guide may be formed on the holding part, and the guide may be inserted by passing through a guide hole formed above a mounting hole into which the pillar trim is assembled to firmly support the holding part to sufficiently withstand the weight of the wiring, thereby preventing the downward-sagging phenomenon and conveniently assembling and safely using the pillar trim.

A vehicle wiring fixture used for mounting wiring (W) installed between a pillar A (10) and a pillar trim (20) according to the present invention includes a main body (100) on which the wiring (W) positioned between the pillar A (10) and a surface of the pillar trim (20) is mounted, wherein the main body (100) includes a ring part (110) surrounding half or more of an outer perimeter of the wiring (W), a pressing flange (120) protruding from a surface adjacent to the ring part (110) and in close contact with the pillar A (10), at least two elastic locking protrusions (130) protruding outward from a central portion of the pressing flange (120) and inserted by passing through an assembly hole (11) formed in the pillar A (10) to perform the locking action, and a holding part (140) extending in a direction of the wiring (W) and added to the main body (100) to support the wiring (W) mounted on the ring part (110) to support the wiring (W) to prevent sagging downward.

In particular, the holding part (140) may be provided with a guide (141) that is forcibly fitted into a guide hole (13) formed above the mounting hole (12) into which a fixing part (21) of the pillar trim (20) is mounted by being forcibly inserted to support the wiring (W) to prevent sagging downward.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a headliner and a pillar A to show a position of the pillar A to which a wiring fixture of a vehicle according to the present invention is applied;

FIG. 2 is a perspective view of the pillar A to show a state in which a wiring is fixed by the vehicle wiring fixture according to the present invention;

FIG. 3 is a perspective view showing a pillar trim separated from the pillar A to show the state in which the wiring is fixed by the vehicle wiring fixture according to the present invention;

FIG. 4 is a perspective view showing a configuration of the vehicle wiring fixture according to the present invention;

FIG. 5 is a cross-sectional view cut in a width direction between the pillar A and a pillar trim to show the state in which the wiring is fixed by the vehicle wiring fixture according to the present invention; and

FIG. 6 is a perspective view showing the state in which the wiring is fixed by the vehicle wiring fixture according to the present invention.

### DETAILED DESCRIPTION OF EXEMPLARY EMBODIMENTS

Hereinafter, exemplary embodiments according to the present invention will be described in detail with reference to the accompanying drawings. Prior to the description, the terms or words used in the specification and claims should not be construed as being limited to their usual or dictionary meanings and should be construed as meanings and concepts consistent with the technical spirit of the present invention according to a principle in which the inventors can appropriately define the concepts of the terms in order to describe their inventions by the best method.

Therefore, since embodiments described in the present specification and the configurations shown in the drawings are only the most exemplary embodiment of the present invention and do not represent all of the technical spirit of the present invention, it should be understood that various equivalents and modified examples capable of replacing the embodiments and the configurations may be present at the time that this application is filed.

### Configuration of Vehicle Wiring Fixture

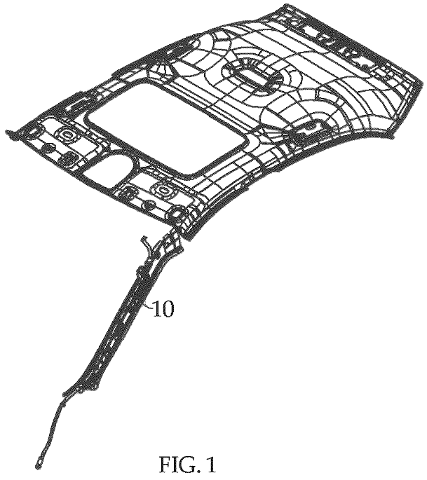

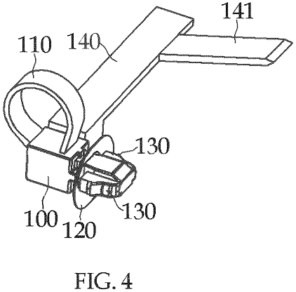

As shown in FIGS. 1 to 6, a vehicle wiring fixture according to the present invention includes a main body 100 including a ring part 110, a pressing flange 120, and two elastic locking protrusions 130.

In particular, as a holding part 140 integrally formed to extend in a longitudinal direction of a wiring W fixed to the ring part 110 is integrally formed to protrude from the main body 100, it is possible to prevent the wiring W from sagging downward due to gravity, thereby preventing the wiring W from covering a mounting hole 12 formed in a pillar A 20 to be positioned under the wiring W, and thus when assembling a fixing part 21 formed on the pillar trim 20 and assembled into the mounting hole 12, the fixing part 21 can be assembled easily and conveniently without having interference.

In addition, a guide 141 may be integrally formed to protrude from the holding part 140, and the guide 141 may be assembled by passing through the guide hole 13 formed to be positioned above the mounting hole 12, thereby sufficiently supporting a load of the wiring W and preventing the sagging phenomenon.

Hereinafter, such a configuration will be described in more detail with reference to the accompanying drawings as follows. Here, the reference numeral “10” denotes a pillar A that supports an edge near a driver's seat among edge portions of a roof panel of a vehicle body, “20” denotes a pillar trim that is assembled in an interior side of the pillar A, and “W” denotes a wiring that is installed between the pillar A and the pillar trim.

### Main Body

As shown in FIGS. 1 to 6, the main body 100 is configured to support the wiring W installed in a space between the pillar A 10 and the pillar trim 20 to prevent the wiring W from sagging downward due to its weight.

As shown in FIGS. 1 to 6, the main body 100 includes the ring part 110, the pressing flange 120, at least two elastic locking protrusions 130, and the holding part 140.

### A. Ring Part

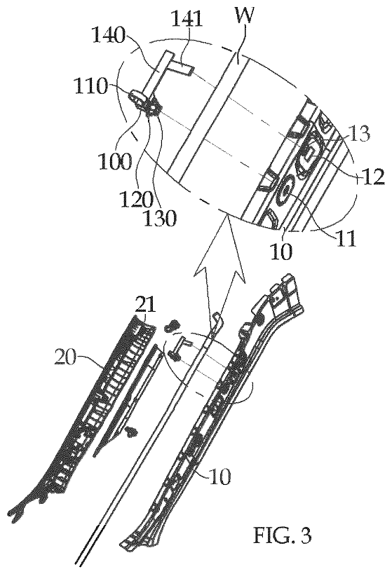

As shown in FIGS. 3, 4, and 6, the ring part 110 is formed at one side of the main body 100 and is used to fix the wiring W.

In this case, the ring part 110 may be formed in a ring shape to be used by being fitted into the wiring W or formed in a “C” shape or may be assembled by being fitted by forcibly pressing the wiring W against an open portion.

In an exemplary embodiment of the present invention, the ring part 110 is preferably formed in a size that may cover half or more of an outer perimeter of the wiring W, thereby preventing the wiring W from being misaligned with or detached from the ring part 110 and stably supporting and fixing the wiring W. In addition, the ring part 110 is preferably in close contact with the wiring W through elastic deformation, thereby stably supporting and fixing the wiring W to be without noise caused by vibrations.

### B. Pressing Flange

The pressing flange 120 is formed to protrude from a surface adjacent to the ring part 110 as shown in FIGS. 3, 4, and 6. In this case, when the elastic locking protrusion 130 to be described below is coupled by being forcibly fitted into an assembly hole 11 of the pillar A 10 and being elastically deformed, as the pressing flange 120 presses a surface of the pillar A 10, the elastic locking protrusion 130 may be firmly fixed to the pillar A 10 by the locking action of the pressing flange 120 and the elastic locking protrusion 130.

### C. Elastic Locking Protrusion

As shown in FIGS. 3, 4, and 6, at least two elastic locking protrusions are integrally formed to protrude outward from the center of the pressing flange 120. In this case, the elastic locking protrusion 130 is formed to pass through the assembly hole 11 formed in the pillar A 10, and when passing through in this way, the elastic locking protrusions 130 face each other, become narrow, and then return to their original state so that the elastic locking protrusions 130 are caught on an edge of the assembly hole 11 to perform the locking action. The drawings show an example in which two elastic locking protrusions are formed to face each other.

### D. Holding Part

As shown in FIGS. 3 to 6, the holding part 140 is a part that is formed parallel to a longitudinal direction of the wiring W fixed to the ring part 110 in the main body 100 to prevent the wiring W from sagging downward due to gravity.

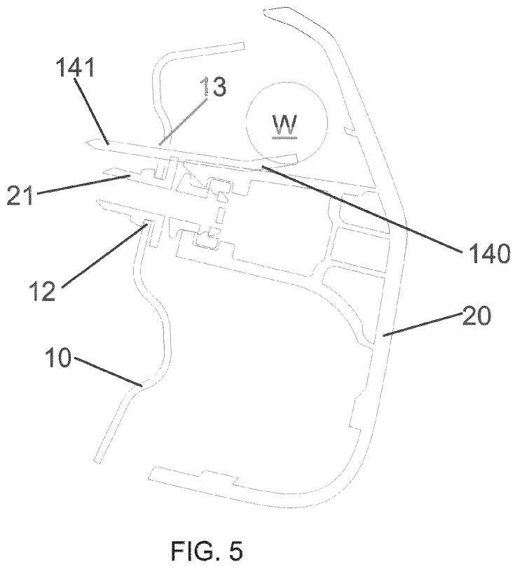

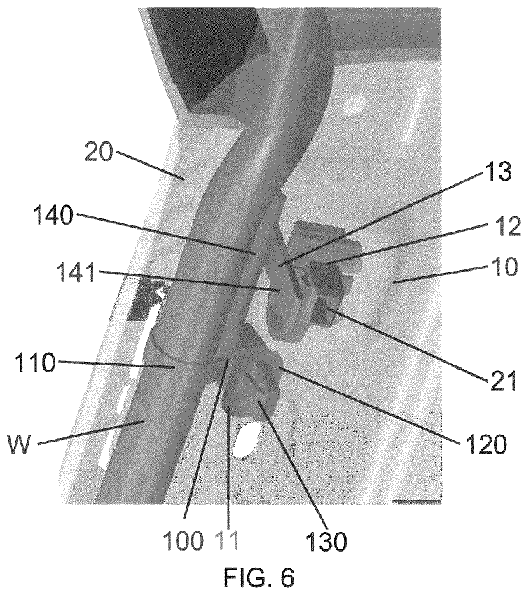

In this case, as shown in FIGS. 5 and 6, the holding part 140 is preferably formed to be positioned above the mounting hole 12 formed in the pillar A 10 so that the fixing part 21 formed on the pillar trim 20 may be assembled when assembling the pillar trim 20 onto the pillar A 10, and thus configured to easily and conveniently perform assembly without having any interference when assembling the pillar trim 20 due to the wiring W caught on the holding part 140 covering or blocking the mounting hole 12.

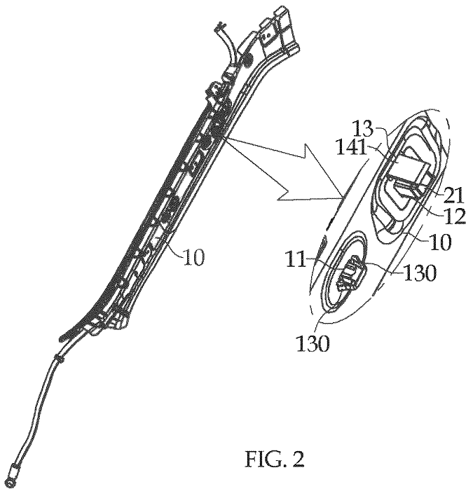

Meanwhile, in an exemplary embodiment of the present invention, as shown in FIGS. 2 to 6, the guide 141 is preferably formed on the holding part 140, and the guide 141 is preferably installed and used to pass through the guide hole 13 formed to be positioned above the mounting hole 12 formed in the pillar A 10. This may allow stable support and fixing of the wiring W to quickly and conveniently perform assembly even when the wiring W becomes thicker and heavier as the number of electric and electronic devices used in a vehicle indoors increases.

As described above, according to the present invention, by forming the wiring mounted between the pillar A and the pillar trim, where there is limited space, to be caught on the holding part to prevent the wiring from sagging downward, it is possible to easily expose the mounting hole used when assembling the pillar trim under the portion that has caught the wiring, thereby more easily and conveniently assembling the pillar trim. In this case, by forming the guide in the holding part and inserting the guide into the guide hole formed above the mounting hole to perform assembly, it is possible to prevent the wiring from becoming bent even when the wiring becomes heavier.

A vehicle wiring fixture used for mounting a wiring installed between a pillar A and a pillar trim according to the present invention has the following effects.

(1) By forming a holding part on a wiring fixture and forming the holding part to support a wiring mounted on the wiring fixture to prevent the wiring from sagging due to gravity, it is possible to prevent the downward-sagging wiring from covering a mounting hole formed in a pillar A so that a pillar trim is assembled onto the pillar A.

(2) Therefore, when a fixing part of the pillar trim is assembled into the mounting hole, it is possible to assemble the fixing part onto a predetermined position easily, conveniently, and accurately without having any interference from the wiring.

(3) In addition, by forming a guide to protrude from the holding part and forming the guide to be assembled by passing through a guide hole formed to be positioned above the mounting hole of the pillar A, it is possible to prevent the holding part from being bent due to a weight of the wiring and easily expose the mounting hole, thereby easily assembling the fixing part of the pillar trim into the exposed mounting hole.

(4) Meanwhile, to supply higher power as the number of electric and electronic devices used in a vehicle indoors increases, a cross section of the wiring needs to be larger. In this way, even when the cross section of the wiring becomes larger, the wiring can be held by the holding part and the guide, and thus can be easily assembled.

What is claimed is:

1. A vehicle wiring fixture used for mounting a wiring (W) installed between a pillar A (10) and the pillar trim (20), comprising a main body (100) on which the wiring (W) positioned between the pillar A (10) and a surface of the pillar trim (20) is mounted,
wherein the main body (100) includes a ring part (110) surrounding half or more of an outer perimeter of the wiring (W), a pressing flange (120) protruding from a surface adjacent to the ring part (110) and in close contact with the pillar A (10), and at least two elastic locking protrusions (130) protruding outward from a central portion of the pressing flange (120) and inserted by passing through an assembly hole (11) formed in the pillar A (10) to perform a locking action, and
a holding part (140) extending in a direction of the wiring (W) is added to the main body (100) to support the wiring (W) mounted on the ring part (110) and supports the wiring (W) to prevent sagging downward.

2. The vehicle wiring fixture of claim 1, wherein the holding part (140) is provided with a guide (141) that is forcibly fitted into a guide hole (13) formed above the mounting hole (12) into which a fixing part (21) of the pillar trim (20) is mounted by being forcibly inserted to support the wiring (W) to prevent sagging downward.
